(19) United States
(12) Patent Application Publication
(10) Pub. No.: US 2019/0050855 A1
(43) Pub. Date: Feb. 14, 2019

(54) BLOCKCHAIN-BASED SYSTEMS, METHODS, AND APPARATUS FOR SECURING ACCESS TO INFORMATION STORES

(71) Applicants: William Martino, Brooklyn, NY (US); Stuart Popejoy, Brooklyn, NY (US)

(72) Inventors: William Martino, Brooklyn, NY (US); Stuart Popejoy, Brooklyn, NY (US)

(21) Appl. No.: 16/044,464

(22) Filed: Jul. 24, 2018

Related U.S. Application Data
(60) Provisional application No. 62/536,053, filed on Jul. 24, 2017.

(51) Int. Cl. G06Q 20/38; G06F 17/30; H04L 9/06

(52) U.S. Cl. CPC G06Q 20/3829; G06F 17/30283; H04L 2209/38; H04L 9/0643; G06F 17/30194

(57) ABSTRACT

Systems, apparatus, methods, and articles of manufacture are described herein for allowing secured access as a service to information in a distributed ledger system (e.g., a blockchain).

### CROSS-REFERENCE TO RELATED APPLICATIONS

The present application claims the benefit of priority of U.S. Provisional Patent Application No. 62/536,053 filed Jul. 24, 2017, entitled “Systems and Methods for Public and Private Blockchain Platforms,” which is hereby incorporated by reference in the present application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This disclosure relates generally to providing access to information on a decentralized ledger (e.g., on a blockchain), and more specifically, to providing code execution-based access to protected data.

### BACKGROUND

Various types of individuals, organizations, and other types of entities (e.g., employers, consumers, financial institutions, retailers, social networking service providers, web-based service providers, etc.) collect and maintain different types of data to which they wish to restrict access. Some prior art solutions rely on distributed ledger systems (e.g., using a blockchain) as a tool for managing and verifying user identifies, so that access to stored data is granted only to those with credentials that are authenticatable through the distributed ledger system. Such prior art approaches, however, fail to utilize on-chain encryption effectively to ensure confidentiality of stored data within a distributed ledger system. Despite the importance of maintaining the security of stored data, user credentials, and the distributed ledger system on which such prior art authentication and data access systems rely, the prior art systems fail to protect stored data adequately or maximize the operational benefits of a blockchain, leaving transaction and data systems exposed to theft, invasions of privacy, and other database security issues.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a diagram of a system according to some embodiments of the present invention;

FIG. 2 is a diagram of a system according to some embodiments of the present invention;

FIG. 3 is a diagram of a system according to some embodiments of the present invention;

FIG. 4 is a diagram of a system according to some embodiments of the present invention;

FIG. 5 is a diagram of a process flow in a system according to some embodiments of the present invention;

FIG. 6 is a diagram of a process flow in a system according to some embodiments of the present invention;

FIG. 7 is a diagram of a process flow in a system according to some embodiments of the present invention;

FIG. 8 is a block diagram of an apparatus according to some embodiments of the present invention;

FIG. 9 is a flowchart of a method according to some embodiments of the present invention;

FIG. 10 is a flowchart of a method according to some embodiments of the present invention; and

FIG. 11 is a flowchart of a method according to some embodiments of the present invention.

### DETAILED DESCRIPTION

### A. Introduction

In accordance with some embodiments of the present invention, one or more novel computer systems, computer apparatus, computer-implemented methods, computerized articles of manufacture, and/or computer-readable media (e.g., a non-transitory computer-readable memory storing instructions for directing a processor) provide for improvements in the efficiency, reliability, and security of distributed ledger computer systems for a variety of applications.

Inventor(s) for this application have recognized that, in accordance with some embodiments described in this disclosure, various types of individuals, organizations, and other types of entities (e.g., employers, consumers, financial institutions, retailers, social networking service providers, web-based service providers, etc.) may find it beneficial to collect and maintain different types of data to which they wish to provide access on a selective basis, in an efficient and secure manner. For example, a social media platform may maintain an archive of content generated and/or uploaded by its users, a financial data service may compile and maintain publicly-available data sets, or a scientific institution may maintain a secure archive of scientific readings. In another example, some types of industries (e.g., insurance, health care, banking) require that sensitive personal information be collected, stored, and securely accessed through strict user identification processes (e.g., in accordance with a regulation-compliant “know your customer” (KYC) process for financial data).

In accordance with embodiments herein, deficiencies of existing systems are remedied by providing systems, apparatus, methods, and articles of manufacture for distributed ledger systems enabling secure and selective access to stored data (e.g., data stored with a code on a blockchain). In some embodiments, for example, specially-programmed code instructions may be generated, stored, and/or replicated across various remotely-situated and cooperative network devices or “nodes.” According to some embodiments, the code may include instructions that cause transmission of one or more specialized chain code blocks or “payloads” to a plurality of remote nodes.

In accordance with embodiments herein, deficiencies of existing systems are remedied by providing one or more novel computer systems, computer apparatus, computer-implemented methods, computerized articles of manufacture, and/or computer-readable media for providing as a service referenceable coroutines (e.g., multi-step, oracle-type processes) via a blockchain platform.

In accordance with embodiments herein, deficiencies of existing systems are remedied by providing one or more novel computer systems, computer apparatus, computer-implemented methods, computerized articles of manufacture, and/or computer-readable media for distributed ledger systems enabling secure and selective access to stored data (e.g., data stored with a code module on a blockchain) by performing one or more of:
receiving a first smart contract comprising a first data table, a first keyset, and a first code module,
   wherein the first code module defines a call to a second smart contract, the second smart contract comprising a second data table, a second keyset, and a second code module,
executing the first smart contract;
determining whether the first smart contract executed successfully; and
performing one of:
   permitting access to the first data table if the first smart contract executed successfully, or
   denying access to the first data table if the first smart contract executed successfully.

In accordance with embodiments herein, deficiencies of existing systems are remedied by providing one or more novel computer systems, computer apparatus, computer-implemented methods, computerized articles of manufacture, and/or computer-readable media for distributed ledger systems enabling secure and selective access to stored data (e.g., data stored with a code module on a blockchain) by performing one or more of:
defining by a first entity a first smart contract that calls a second smart contract defined by a second entity;
compiling the second smart contract inline in the first smart contract; and
executing the first smart contract to access a data table of the second smart contract.

In accordance with embodiments herein, deficiencies of existing systems are remedied by providing one or more novel computer systems, computer apparatus, computer-implemented methods, computerized articles of manufacture, and/or computer-readable media for distributed ledger systems configured for committing transactions to the ledger using a quorum-based consensus protocol (e.g., when a threshold number and/or a fixed number of nodes in a distributed ledger system produce the same hash or other proof message). In one example, the number of nodes in a plurality of nodes required to produce the same proof message is at least a majority of those nodes.

In accordance with embodiments herein, deficiencies of existing systems are remedied by providing one or more novel computer systems, computer apparatus, computer-implemented methods, computerized articles of manufacture, and/or computer-readable media for distributed ledger systems enabling secure and selective access to stored data (e.g., data stored with a code module on a blockchain) by performing one or more of:
selecting a transaction (e.g., receiving a transaction submitted from a client device of a blockchain platform);
generating a quorum proof message based on the transaction (e.g., an incremental hash of a hash-chain);
transmitting the generated quorum proof message to a plurality of nodes; and
determining whether at least a threshold number of nodes of the plurality of nodes generated the same quorum proof message based on the same transaction (and/or based on the same hash-chain).

In some embodiments, for example, specially-programmed code instructions may be generated, stored, and/or replicated across various remotely-situated and cooperative network devices or “nodes.” According to some embodiments, the code may include instructions that cause transmission of one or more specialized chain code blocks or “payloads” to a plurality of remote nodes.

### 1. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

“Ledger” is used in this disclosure to refer to an ordered series of messages that each detail a specific, command, action, and/or transaction to take place.

“Byzantine fault tolerant (BFT) consensus” is used in this disclosure to refer to a mechanism allowing a set of nodes to come to agreement about some common truth in spite of a subset of nodes being malicious or faulty.

“Quorum BFT consensus” is used in this disclosure to refer to a consensus protocol in which each node of a blockchain system acts independently to gather a proof message (e.g., PPK-signed evidence) and a threshold number of a plurality of nodes must generate the same proof message before the system commits to a state change. The term “majority BFT consensus” is used in this disclosure to refer to a specific quorum BFT consensus protocol in which a majority consensus of a plurality of permissioned nodes of a blockchain system is required to commit a state change. Quorum BFT consensus protocols, such as Kedena LLC's ScalableBFT consensus protocol, use the core feature of a hash chain, in which the incremental hash of transaction #N implies successful replication of all previous transactions (e.g., N−1, N−2, etc.). Additional technical description of the ScalableBFT consensus protocol that may be suitable for use in implementing some embodiments of this disclosure is provided in U.S. Provisional Patent Application No. 62/536,053, which is hereby incorporated by reference in this disclosure. In some embodiments, a blockchain system using majority BFT consensus stores transactions in a hash-chain which advantageously allows throughput to not be a function of cluster size. In one example implementation of a majority BFT consensus protocol, a leader node (which may or may not be trusted) adds new transactions to its log, replicates the transaction to the followers (e.g., through an AppendEntry function) and also transmits evidence of its latest log, which includes the log's incremental hash (e.g., AppendEntryResponse (AER)). Each node collects AERs from other nodes, checking hashes against their own respective log. When a node collects a majority of AERs with matching hashes, the node commits the new transactions. The leader node may be configured with the ability to order new transactions (but may have no other special abilities compared to other nodes).

The term “node” is used in this disclosure to refer to a computing device (e.g., a physical and/or virtual machine), such as a server, in a blockchain system.

### 2. Summary

The inventors in this disclosure describe various blockchain solutions. Some embodiments are suitable for implementation for enterprise-grade private blockchain solutions and/or public blockchain deployment. The various blockchain solutions are described with respect to a novel and robust platform for smart contracts. The various novel features (and novel combinations of features) provide a platform with the security, stability, and performance necessary for high assurance smart contracts.

In accordance with some embodiments, smart contracts may be established using programming languages that provide for one or more of the following features: (a) Turing-incompleteness, (b) human-readable code (e.g., stored on the blockchain), (c) safe import of other on-chain contracts, and/or (d) formally verifiable by computers. Although some embodiments may be described in this disclosure are discussed with respect to the Pact programming language of Kadena LLC by way of example of a language having one or more such features, it will be readily understood that embodiments are not limited to Pact or to any other programming language. In accordance with one or more embodiments, the programming language has associated tools and/or other features that facilitate the review of the smart contract's business logic by non-programmers (e.g., by executives and attorneys).

According to some embodiments, novel computer systems, networks, and processes allow for the establishing of cryptocharters through custom, generalized governance mechanisms. Cryptocharters streamline upgrades and data migrations without resorting to hard-forks of the network. In addition, according to some embodiments, a cryptocharter may support the safe interaction between contracts and trusted “off-chain” oracle information sources.

### 3. Governance

The inventors have recognized that governance has emerged as a major issue in blockchain, with particularly serious implications for the adoption of smart contracts beyond typical crypto-currency applications like token issuance. Various embodiments of the novel blockchain platform described in this disclosure utilize a flexible, programmable solution by which smart contracts can become autonomous yet still governable: a “Cryptocharter.”

The inventors have also recognized that prior art solutions are subject to issues of hard fork misuse. Blockchain technology requires client software that runs a protocol that represents the blockchain itself. Like all software, from time to time the protocol must be upgraded. To achieve this, the network undergoes an intentional hard fork wherein the network switches over to a new version of the system. Hard forks are an inherently external event and as such are able to change any aspect of the blockchain itself. They are only restricted by what the community deems appropriate.

The advent of smart contracts has, unfortunately, lead to their misuse. Because hard forks have “god rights” they can be used to resolve contentious community issues concerning the blockchain's entries. At worst, such a hard fork can “split” the blockchain itself wherein dissenters continue to mine the “classic” version. Even for non-controversial changes, the fact that centrality is re-asserted for the purpose of adjusting ledger entries (usually through the authority of community leaders) is not only antithetical to blockchain's trustless ethos but reveals the lack of a mature governance process that is critical to improving the utility of blockchain for high-assurance environments.

With smart contracts like those implemented using Ethereum, the issue becomes more acute, as there is no way to upgrade deployed smart contract code without invoking a centralized authority. Either a contract's owners hold a key endowed with the rights to upgrade redirect to a new version of the contract or, as is the case of “ownerless” contracts like the concept of a decentralized autonomous organization (DAO), the community's leaders need to orchestrate an impromptu, extremely controversial hard fork. Current approaches for ownerless contracts, like Bancor's use of a “pilot phase” where bug bounties are made available and addressed, are half-measures at best. After the pilot phase the contract is made permanently nonupgradeable—a hard fork would be the only way to address an issue post-pilot.

The inventors have recognized that, in accordance with some embodiments, a mature smart contract system should support an ability to receive upgrades to smart contracts for anything at any point in its lifecycle (e.g., from addressing critical issues to effecting strategic enhancements), without requiring a hard fork. One or more embodiments in this disclosure provide for mechanisms within a system to provide governance over the application of upgrades and fixes to the contracts deployed on the blockchain system, without requiring a hard fork. Programming approaches using such mechanisms may be utilized to provide operational security for both private and public blockchain systems.

According to some embodiments, a “keyset” refers to an authentication mechanism that supports multiple keys and a programmable threshold of keys used to sign a transaction. In one example, a programming language with a keyset-based approach provide a centralized solution for validating upgrade transactions.

### 4. Cryptocharters

For a public chain, various embodiments of this disclosure allow for a generalized mechanism (as opposed to a centralized mechanism suitable for a private enterprise blockchain) that makes possible the expression of arbitrary governance regimes. For example, the generalized mechanism may provide native support of community governance wherein a vote on a particular upgrade or change can be both decided upon and enacted by stakeholders. A “cryptocharter” is a type of smart contract that natively supports arbitrary governance regimes and has a formalized governance mechanism. According to some embodiments, the programming language may require the establishment of a particular governance model. For example, in some versions of the Pact language this is a syntactic requirement; it is not possible to create a smart contract without specifying its governance model. Moreover, with the inclusion of flexible governance, the notion of “distributed autonomous organizations” can reach its full maturity (e.g., allowing it to operate like a business that both functions and is governed according to the details specified by its cryptocharter).

According to some embodiments of this disclosure, a smart contract may or may not be autonomous, but may require a governance mechanism that supports arbitrary models, as discussed above. Contract authors explicitly decide on the contract's governance structure during the contract's construction. The mechanism itself may be expressed as Turing-incomplete code found within the contract.

In one embodiment, the founders of a cryptocharter may specify the governance function at inception as a pass-fail mechanism that, for instance, enacts or validates some kind of voting process, after which the contract can be upgraded. The flexibility means indeed any governance is possible, including but not limited to hard fork governance.

According to some embodiments, when a smart contract is created or upgrade, it can create tables to store data in. In one or more embodiments, each table is owned by one and only one module, with ownerships meaning “raw table access.” For example, a contract is said to “guard” its tables by as access to them is strictly limited to the access provided by the smart contract's functions. In other words, in accordance with some embodiments, all table access is pursuant to the logic expressed by a contract's functions. Thus, during a contract upgrade, when one has access to the contract itself, one may also perform direct database operations that override the normal “guarding” mechanism that prohibits external code from accessing a charter's database table.

### 5. Programming Solutions for Smart Contracts

According to some embodiments, the programming language for an application on which a blockchain platform is based may run only in a deterministic environment in which code can only compute on inputs and the accumulated state within the environment. Other blockchain protocols operate in deterministic environments; however, various embodiments of this disclosure utilize a programming language having one or more specialized features and/or combinations of features providing technical improvements in the domain, on both private and public blockchain, that are superior to the current solutions for smart contracts.

According to one embodiment, a blockchain platform is based on a programming language that has one, some, or all of the following characteristics:
a) Turing-incomplete (i.e., not Turing-complete);
b) prohibits recursion (i.e., no function can call itself) or unbound looping;
c) allows inlining (e.g., allows a function call to be replaced with the unchanged function code during compiling);
d) prohibits use of null values in the code module or in data tables;
e) enforces totality;
f) program always logically maps out to a “tree” having one or more terminal points; and/or
g) prohibits jumps to memory addresses.

According to some embodiments, a blockchain platform is based on a programming language having one or more of the following features:
a) Human-readable code; and/or
b) Safe import of other on-chain contracts.

In some embodiments, the programming language comprises human-readable code stored on the blockchain. Human-readable code allows non-technical stakeholders (and programmers) to easily verify on-chain logic.

A human-readable approach to code facilitates the use of name-based resolution for functions and imports. Transactional operations, as discussed in this disclosure, are valid code that call contract functions by name. Smart contracts developed using a language like Pact, for example, can import and use other already-installed smart contracts by name. In accordance with some embodiments of this disclosure, when installed in code, module dependencies are dereferenced and “inlined” by an interpreter (e.g., a Pact interpreter by Kadena LLC) for faster execution. Advantageously, this allows the benefit of rejecting invalid calls at install time.

According to some embodiments, safe import of functions (including other smart contracts) is guaranteed by allowing for users to specify module hashes as part of an import statement, which is enforced by the runtime. Without checks performed at install time to ensure referenced code is correct, “library functions” and other shared code may be unsafe. In contrast, an import functionality in accordance with some embodiments of this disclosure means that on-chain code is available both for code reuse (e.g., utility modules that do not maintain database state) as well as for service provision.

Accordingly, some embodiments of the present invention provide for code that calls an external module function in a manner that is identical in form to a local function call and offers the same level of assurance, including the ability to perform direct, whole-program formal verification that tests the entirety of the code whether it be imported or local. As a result, some embodiments of this disclosure allow for services to be offered on-chain/internally and to customers/externally. Allowing the import of other on-chain contracts, in accordance with some embodiments, improves efficiency and reuse of code and contracts, and facilitates the development of a blockchain-based services architecture. For example, companies may utilize a blockchain platform to offer both data and logic to other organizations and consumers on-chain.

In one or more embodiments, a flexible programming language suitable for certain implementations may provide language support for critical functionality, boosting efficiency, productivity, and simplicity; a powerful key-value database metaphor; public-key authorization primitives; and representation of all datatypes using a native JSON representation.

According to some embodiments, the programming language for developing and executing smart contracts is preferably an interpreted language (i.e., the code submitted to the blockchain is the code that is executed, including any imported code). A key advantage of an interpreter-based approach to compiling (versus code that must be compiled to bytecode before execution, such as code for Ethereum Virtual Machine (EVM)) is the ability to inspect code that is installed on the blockchain. The bytecode required for execution on platforms like EVM is typically too low-level to be human-readable.

### 6. Formal Verification

Pact is unique amongst smart contract languages in offering a whole program formal verification (FV) solution, which yields an unprecedented assurance of smart contract safety. Formal verification refers to a process by which code is analyzed and transformed to reveal its semantic structure by representing it as a set of mathematical equations. These equations can then be used to prove assertions or theorems about its correct operation. This is radically different than normal software testing, as FV tools can validate correct behavior over infinite input spaces and states, whereas regular programmers can only test for known situations. The nature of FV generally and the implementation of Pact's FV system specifically is discussed is significant depth in the technical details and examples sub-section, with the preceding sections being devoted to a more approachable discussion of FV.

In accordance with some embodiments discussed in this disclosure, a blockchain platform is provided that utilizes a programming solution that allows for the compilation of programming code for formal verification. The compiled code can be directly used by experts to author complex assertions about correct behavior. Turing-incomplete code is advantageous in that it may be more easily compiled for formal verification. In one example, the Pact programming language may be compiled directly to the SMT-LIB2 language, which may be used by formal verification tools such as the Z3 theorem prover5 by Microsoft corporation.

According to some embodiments, FV may be performed “off-chain,” before deployment to the blockchain. The module hash mechanism described above ensures deployed code matches the verified codebase. This extends to the entire smart-contract ecosystem, as users of your code will independently verify the intention and assumptions you provide in the documentation. Additionally, some types of languages (e.g., Pact) allow for inlining imported code, allowing users of a developer's code to layer their own assertions in addition to the developer's. A description of Pact and Pact's code-inlining system that may be suitable for use in implementing some embodiments of this disclosure is provided in U.S. Provisional Patent Application No. 62/536,053, which is hereby incorporated by reference in this disclosure. Pact, for example, guarantees that deployed code cannot change, meaning your FV-IEL results are valid for the lifetime of that code.

Accordingly, in some embodiments, FV is not “bundled” with on-chain install. While it can seem attractive to “bundle” FV with on-chain install, failing the install if assertions are disproven, it is unnecessary, thanks to module hashes, and inappropriate for blockchain execution. A formal verification process such as the Z3 process may be relatively fast for its domain, but very CPU-intensive and can easily take minutes/hours depending on the complexity of the assertions. Accordingly, FV, as well as any other unit or regression testing, preferably occurs before deployment, and then enjoys the stability of inlined code once deployed on the chain. According to some alternative embodiments, FV may occur with on-chain install, if deemed desirable for a particular implementation.

### 7. Pact-Based Smart Contracts

The term “pacts” will be used in this disclosure to refer to coroutines to orchestrate asynchronous sequential execution for confidential “blinded” transactions. According to some embodiments of this disclosure, pacts make the automation of oracle interactions easy and safe by allowing users to structure atomic, multi-step, call and response interactions. With pacts, a single function can yield and resume at distinct “steps” which provides a form of automated multi-phase commit. If steps fail, rollbacks are specified to reverse changes post-failure. Accordingly, various embodiments of this disclosure may comprise execution environments that support atomic transactions at the per-transaction level and/or for multi-transaction scenarios.

According to some embodiments of this disclosure, pact-based smart contracts comprise three elements: tables, keysets, and a code module. In some embodiments, the data tables are “key-row” and schema-less and support a versioned, columnar history. Keysets for pacts may group a set of public keys with a predicate function to comprise a keyset rule for authorization. Keysets may be defined globally or at a per-row level.

As used in this disclosure, the code module for a smart contract is where all code is declared governing the smart contract. The code module comprises function definitions and “pact” definitions: multi-step functions for confidential execution. The code module accordingly defines the access to and control of its smart contact, including all access to the tables of the smart contract. In this way the code module provides control over the copy of the data table available locally from the chain, in a more secure way than that in which an API may provide access to and control of data on a remote server.

According to some embodiments, contract operations are executed by sending in one or more module function calls. A given blockchain message preferably comprises a single transaction in the database sense of atomic execution: if any failure occurs, the entire operation is rolled back to the state before the function was executed.

According to some embodiments, the querying of contract data is configured for data export (e.g., as opposed to heavy analytical processing). For example, the inventors have recognized that performance may be optimized by having queries executed in a blockchain's “local mode”; most historical queries take a transaction identifier that guarantees the validity of the data up until that transaction identifier in the blockchain.

According to various embodiments of the present invention, the code of a smart contract resembles in some ways stored procedures in that they are deployed into the blockchain, exposing functions that house the detailed transaction logic. Transactions are executed by sending in pieces of code that call exposed functions with appropriate argument values. In a pact-based system, one or more tables may be guarded by its associated code module, preventing direct access to the table, and allowing the code module to define safe and stable access to the table.

As noted above, in accordance with some embodiments, a blockchain system is provided that allows for atomic execution of smart contracts in which updates are committed only upon successful completion of the entire code path, avoiding errors associated with memory address jumps and/or recursive code logic.

According to some embodiments, in order to define a table for a smart contract, a module must also be defined to govern access to the table. Direct access to the table may be limited to administrators if desired and secured by the module's administrative keyset. In some embodiments, code declared within a module may have unlimited access to the table.

With the code module governing access to the table in a smart contract, access to the table can only occur by calling module functions. In some embodiments, contract authors may use specific keysets to provide desired user-level authorization schemes. Administrative access may be defined in order to allow for data migration and/or emergency procedures.

According to some embodiments, a blockchain system may be configured for use with one or more public-key signing schemes (e.g., like that of Bitcoin™) in which incoming transactions are signed with a provided public key (or keys). According to some embodiments of a blockchain system, before executing any code the execution environment runtime first verifies all signatures (e.g., aborting a transaction on a verification failure). If all signatures are verified, the execution environment may be populated with any verified keys. Executed code can then match verified keys against one or more predefined rules (a “keyset”) that combine a defined set of public keys with a keyset predicate function. In some embodiments, the keyset predicate function may specify logic determining how transaction keys may match against the keyset, for example: one match only, match all, match a majority, etc.

As discussed above, a pact defines a function comprising a plurality of defined steps to be executed by different entities as sequential transactions on the blockchain. According to some embodiments, a pact can yield and resume at key points in a single function execution. An example execution of a pact-based smart contract for an example payment transfer involving functions that can yield and resume is described in U.S. Provisional Patent Application No. 62/536,053, which is hereby incorporated by reference in this disclosure.

### 8. Oracle Processes and Two-Party Escrow

The inventors have recognized that deterministic smart contracts preferably should allow a way to retrieve and authenticate data from the outside world. An “oracle” process is a type of process that typically must execute “off-chain,” like obtaining a stock price or running some intensive or indeterminate computation using an API call. The data returned from this type of process is preferably accompanied by some proof of provenance (e.g., a PK signature) to establish the recipient's trust in the obtained data. The inventors have recognized that writing smart contract code to implement standard oracle processes on a blockchain is technically difficult and poorly-understood by the average developer.

According to some embodiments, a programming solution optimized for pact-based smart contracts comprises one or more coroutines to orchestrate asynchronous sequential execution, allowing for the easy and safe automation of oracle functionality using smart contracts.

Some embodiments of this disclosure provide for an advantageous combination of simplified oracle creation with a service-oriented blockchain platform, greatly enhancing the utility and sustainability of smart-contract business on the blockchain.

According to some embodiments for providing oracle functionality, information may be stored securely on the blockchain and guarded by an associated smart contract; the information may be accessed only if the smart contract executes successfully. In this way the on-chain oracle allows for replication of some server functionality that would otherwise be provided by an off-chain oracle process (e.g., using an API call to request the data). According to some embodiments, secured information may be accessed on the blockchain by one entity without another entity having to provide the requested information in response to a request or granting the requesting entity control over the entity hosting the information.

According to some embodiments, one entity maintaining an oracle contract on a blockchain may license the right to execute the oracle contract against the associated information.

According to some embodiments, smart contracts may interact with oracles using either a push-based or a pull-based approach. In a push-based approach, the oracle's external system periodically updates the data in its on-chain representation stores. This data can then be queried (e.g., for a fee or other exchange of value) by another contract.

According to some embodiments, in a pull-based interaction, a smart contract may initiate an off-chain oracle process by requesting external information. In one example, an off-chain oracle process may be structured around pacts, where the first step is the request for external information sent to the oracle and the second step is the user code that consumes the oracle's response.

For a public chain implementation, pact functionality may automate a pull-based oracle process. A requesting contract, for example, may initiate a pull-based oracle process by calling the pact in the same manner as any transactional function call. This executes the first step which performs the necessary setup (e.g., a database read, a payment escrow, etc.). The first step may then yield with a special call (e.g., “yield-ext”) that specifies the keyset to validate the oracle response. In one embodiment, the special call may comprise a block height and/or time expiration prior to which the requester cannot force a rollback.

Further according to this example process, an oracle may be notified at this point and may processes the request. When ready, the oracle may respond by signing a special resume transaction with the response data and may reference a unique identifier that identifies the original transaction. In accordance with some embodiments, the pact may now resume at the second step, automatically enforcing the previously-specified keyset. The code can now use the provided data with a special binding form (e.g., “resume-ext”) and finalize the transaction (e.g., including an escrow fulfillment).

In some embodiments, failures of any sort such as timeout and business rule violations, etc., invoke whatever rollbacks are specified in the first step, such as an escrow refund. Because pact-based operations maintain state over the multi-transactional flow, developers no longer need to program this behavior “from scratch” and are guaranteed that failures will result in the execution of rollback, providing a more secure distributed ledger environment.

The following example code provides an example of a coroutine (a pact) defining a rollback condition for a payment transaction involving a debit from a payer and a corresponding credit to a payee:

(defpact pay (payer payer-entity payee payee-entity amount date)

; step 1: debit from payer

(step-with-rollback payer-entity
(debit payer amount date {“payee”: payee})
; rollback if step 2 fails
(credit payer amount date))

; step 2: credit to payee

(step payee-entity
(credit payee amount date {“payer”: payer}))
   )

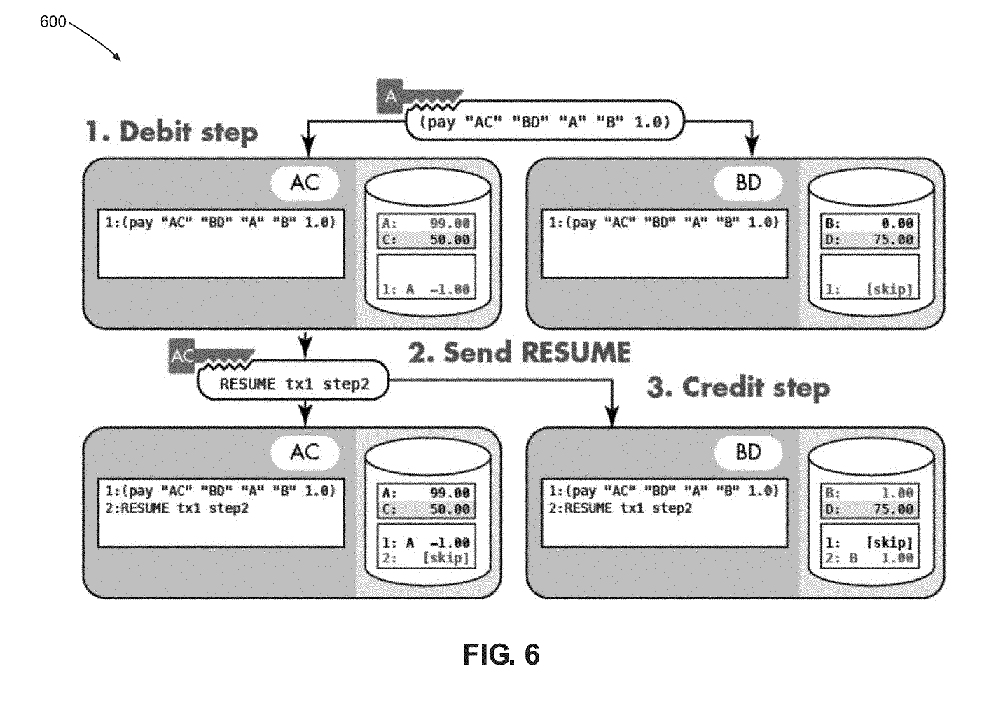

An example of implementation of the flow of this example multi-step coroutine is depicted in FIG. 6. Specifically, if the defined “step 2” (the crediting of the payment amount to the payee's account) fails, then the defined “step 1” is rolled back by crediting the amount debited from the payer in “step 1.”

According to some embodiments, pacts are able to create special-purpose per-pact “pact accounts,” which can only be accessed within the code of the executing pact. This allows for secure escrow functionality where the third party may be represented by the state of the chain (likely temporal) itself. A technical description of how this process works and that may be suitable for use in implementing some embodiments of this disclosure is provided in U.S. Provisional Patent Application No. 62/536,053, which is hereby incorporated by reference in this disclosure. In one or more embodiments, during execution, steps of a pact form a region in the call stack where code has the capability to create and interact with pact accounts. As pacts are multi-step affairs with pre-specified actors specified for each step, they allow for the initiator to specify: (a) the logic used for each step, (b) who can step the pact forward at each step, and (c) the logic used to determine if and when they unilaterally trigger a rollback.

The following hypothetical escrow scenario is provided as a metaphor for potential implementations of a two-party escrow using pacts and example transaction rules. In the scenario, Bob wants to buy an apple from Alice for $1. Though Bob and Alice will never see each other and thus cannot make the exchange, they will both see Sam. Bob gives Sam $1 and instructs him in three specific ways: (a) how to verify that the apple is the one that Bob wants, is not rotten, is the correct type, etc.; (b) if the apple provided by Alice fails any criteria defined in (a), do not let Alice try to present the same apple again, cancel the transaction, and return Bob's money; and (c) if Alice does not provide the apple within a predefined time period (e.g., 24 hours), then Bob may unilaterally cancel the transaction at his discretion. A copy of the instructions are sent by Sam to Alice, who can then decide if she wants to hold up her end of the deal before the time runs out.

This is effectively how two-party escrows via pacts work, with the exception that Sam is the blockchain itself. Bob, when constructing the pact, effectively programs Sam's instructions.

Asynchronous pull-based oracles services are particularly interesting when applied to two party escrows. Specifically, they allow for an entire step to be dropped from the cycle. Because of how pacts function, the second step of the pact can execute with the authorizations given to the first step—the initiator of the pact authors it entirely and thus has full control/security regarding what code will be run when the second step takes place. Thus Bob can ask an oracle for a some off-chain data in the first step and, when the oracle responds thus triggering the second step to start, it can continue execution as if Bob signed the trigger transaction without requiring Bob's signature.

According to some embodiments, rollbacks are not automated in that they require a new transaction to be triggered. In one example, from initial request to timeout only two actions can cause a rollback:
a) The second party, which in this case is an oracle, issues the rollback command for the pact in question. This can occur if the oracle service decides not to service the pact though it is more likely that oracle will simply not respond (as some fee will be required to execute the rollback transaction and reclaim the escrow). In that case, the initiator need to wait for the timeout to pass and issue the rollback themselves to reclaim their escrowed funds.
b) Any step of the pact fails. This can occur if the oracle provides bad/stale data causing the second step to error out. As every transaction has a cost, and the oracle can check that their data will not cause the second step to error ahead of time. Regardless of the reason, when a rollback occurs, the escrow is refunded to the initiator.

Some embodiments of the present disclosure provide a novel blockchain platform system that may comprise only public blockchains, only private blockchains, or both at least one public blockchain and at least one private blockchain.

According to some embodiments, trusted oracle services may be configured to provide (and potentially charge for) access to pull- and/or push-based services for various types of data, including private/confidential information and/or information that is otherwise publicly available.

The inventors have recognized that making data available through a contract in the pure, deterministic context of a blockchain may have value in some types of implementations beyond the value of the data itself. Oracles can provide more than just data; they may act as trusted parties for executing computationally-heavy logic off-chain, or even executing complex Merkle verifications that a light client would rather not have to recalculate themselves.

Because data tables, which in some embodiments may act as a repository for push-based information, are guarded by the contract that owns them (i.e., access to the information is controlled by the contract code), the data itself can be fully public to external actors while also being monetizable for other contracts that wish to access the data themselves (and perhaps take advantage of associated logic).

According to some embodiments, oracles may be implemented in a platform for providing cross blockchain services, providing push-based checkpoint data, and/or pulling the latest chain state on demand. Oracle services in some embodiments may also benefit from the ability to easily migrate from public to appropriately-configured chain settings on a private platform.

### B. General Systems, Structures, and Processes

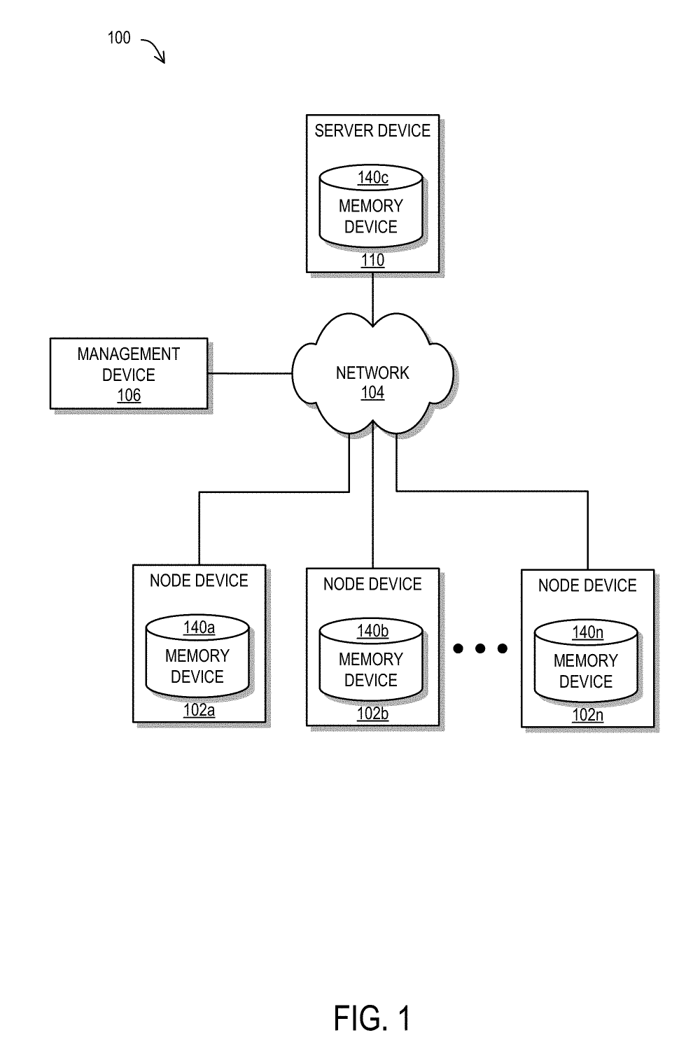

Referring first to FIG. 1, a block diagram of a system 100 according to some embodiments is shown. In some embodiments, the system 100 may comprise a plurality of node devices 102a-n, a network 104, a management device 106, and/or a server device 110. According to some embodiments, any or all of the devices 102a-n, 106, 110 may comprise and/or be in communication with a data storage and/or memory device 140-1a-n, 140-2. Each node device 102a-n may comprise a local memory device 140-1a-n, for example, and/or the server device 110 may comprise a network memory device 140-2. As depicted in FIG. 1, any or all of the devices 102a-n, 106, 110, 140-1a-n, 140-2 (or any combinations thereof) may be in communication via the network 104. In some embodiments, communications between and/or within the devices 102a-n, 106, 110, 140-1a-n, 140-2 of the system 100 may be utilized to provide and manage a distributed ledger. The server device 110 may, for example, interface with one or more of the node devices 102a-n and/or the management device 106 to execute multiple instances of specially-programmed smart contracts (not depicted) stored in any or all of the memory devices 140-1a-n, 140-2 and/or provide a specially-structured interface via which a user may obtain, verify, execute and/or modify smart contract information.

Fewer or more components 102a-n, 104, 106, 110, 140-1a-n, 140-2 and/or various configurations of the depicted components 102a-n, 104, 106, 110, 140-1a-n, 140-2 may be included in the system 100 without deviating from the scope of embodiments described herein. In some embodiments, the components 102a-n, 104, 106, 110, 140-1a-n, 140-2 may be similar in configuration and/or functionality to similarly named and/or numbered components as described herein. In some embodiments, the system 100 (and/or portion thereof) may comprise a blockchain-based program, system, and/or platform programmed and/or otherwise configured to execute, conduct, and/or facilitate one or more methods described in this disclosure.

The node devices 102a-n, in some embodiments, may comprise any types or configurations of computing, mobile electronic, network, user, and/or communication devices that are or become known or practicable. The node devices 102a-n may, for example, comprise one or more Personal Computer (PC) devices, computer workstations (e.g., an underwriter workstation), tablet computers, such as an iPad® manufactured by Apple®, Inc. of Cupertino, Calif., and/or cellular and/or wireless telephones, such as an iPhone® (also manufactured by Apple®, Inc.) or an LG Optimus™ Zone™ 3 smart phone manufactured by LG® Electronics, Inc. of San Diego, Calif., and running the Android® operating system from Google®, Inc. of Mountain View, Calif. In some embodiments, the node devices 102a-n may comprise devices owned and/or operated by one or more users. According to some embodiments, the node devices 102a-n may communicate with the server device 110 via the network 104 to conduct transactions and/or processes, in accordance with one or more processes as described herein.

In some embodiments, the node devices 102a-n may interface with the server device 110 and/or the management device 106 to effectuate communications (direct or indirect) with one or more other node devices 102a-n (such communication not explicitly shown in FIG. 1) operated by other users, for example. In some embodiments, the node devices 102a-n may interface with the server device 110 to effectuate communications (direct or indirect) with the management device 106 (such communication also not explicitly shown in FIG. 1). In some embodiments, the node devices 102a-n and/or the server device 110 may execute separate instances of blockchain algorithm that cause transactions to be managed, distributed, and/or encrypted in a verifiable manner. As described herein, for example, the node devices 102a-n and/or the server device 110 may communicate with the management device 106 to execute a cryptographic service utilized to securely disseminate and/or derive consensus for one or more smart contracts with respect to a plurality of the node devices 102a-n.

The network 104 may, according to some embodiments, comprise a Local Area Network (LAN; wireless and/or wired), cellular telephone, Bluetooth®, Near Field Communication (NFC), and/or Radio Frequency (RF) network with communication links between the server device 110, the node devices 102a-n, the management device 106, and/or the memory devices 140-1a-n, 140-2. In some embodiments, the network 104 may comprise direct communications links between any or all of the components 102a-n, 106, 110, 140-1a-n, 140-2 of the system 100. The node devices 102a-n may, for example, be directly interfaced or connected to one or more of the server device 110 and/or the management device 106 via one or more wires, cables, wireless links, and/or other network components, such network components (e.g., communication links) comprising portions of the network 104. In some embodiments, the network 104 may comprise one or many other links or network components other than those depicted in FIG. 1. The node devices 102a-n may, for example, be connected to the server device 110 and/or the management device 106 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140-1a-n, 140-2 of the system 100. The network 104 may comprise one or more cellular telephone networks with communication links between the node devices 102a-n and the server device 110, for example, and/or may comprise the Internet, with communication links between the server device 110 and the management device 106 and/or one or more of the memory devices 140-1a-n, 140-2, for example.

The management device 106, in some embodiments, may comprise any type or configuration of a computerized processing device, such as a PC, laptop computer, computer server, database system, and/or other electronic device, devices, or any combination thereof. In some embodiments, the management device 106 may be owned and/or operated by a third-party (i.e., an entity different than any entity owning and/or operating either the node devices 102a-n or the server device 110; such as certificate, authentication, and/or cryptographic service provider). The management device 106 may, for example, execute one or more web services that provide for centralized blockchain cryptographic functionality. In some embodiments, the management device 106 may receive block chain data from one or more of the node devices 102a-n and/or the server device 110, may apply a hash algorithm to the received data, and may transmit the encrypted data to each of the node devices 102a-n and the server device 110 (e.g., for storage in local copies of a blockchain-based ledger). According to some embodiments, the management device 106 may comprise a plurality of devices and/or may be associated with a plurality of third-party entities.

According to some embodiments, any one or more of the node devices 102a-n, the server device 110, and/or the management device 106 may comprise one or more virtual processors and/or one or more virtual machines, such as those available using virtualization products such as VirtualBox™ by Oracle Corporation. In one example, the management device 106 may comprise a physical CPU assigned to a virtual machine (VM). (A physical CPU allocated to a VM may be referred to in this disclosure as a “virtual processor.”). One or more VMs may be utilized in accordance with various embodiments of the present invention.

In some embodiments, the server device 110 may comprise an electronic and/or computerized controller device, such as a computer server communicatively coupled to interface with the node devices 102a-n and/or the management device 106 (directly and/or indirectly). The server device 110 may, for example, comprise one or more PowerEdge™ R830 rack servers manufactured by Dell®, Inc. of Round Rock, Tex. which may include one or more Twelve-Core Intel® Xeon® E5-4640 v4 electronic processing devices. In some embodiments, the server device 110 may comprise a plurality of processing devices specially-programmed to execute and/or conduct processes that are not practicable without the aid of the server device 110.

The server device 110 may, for example, execute one or more coded rules to manage a blockchain ledger for a plurality of smart contracts. According to some embodiments, the server device 110 may be located remote from one or more of the node devices 102a-n and/or the management device 106. The server device 110 may also or alternatively comprise a plurality of electronic processing devices located at one or more various sites and/or locations.

According to some embodiments, the server device 110 may store and/or execute specially programmed instructions to operate in accordance with embodiments described herein. The server device 110 may, for example, execute one or more programs, modules, and/or routines that facilitate the provision, defining, and/or access to smart contracts, e.g., in an online environment, as utilized in various blockchain applications as described herein.

According to some embodiments, the server device 110 may comprise a computerized processing device, such as a computer server and/or other electronic device to manage and/or facilitate transactions and/or communications regarding the node devices 102a-n.

In some embodiments, the node devices 102a-n, the management device 106, and/or the server device 110 may be in communication with the memory devices 140-1a-n, 140-2. The memory devices 140-1a-n, 140-2 may comprise, for example, various databases and/or data storage mediums that may store, for example, blockchain instructions, smart contract data and/or other blockchain data, cryptographic keys and/or data, login and/or identity credentials, and/or instructions that cause various devices (e.g., the server device 110, the management device 106, and/or the node devices 102a-n) to operate in accordance with embodiments described herein.

The memory devices 140-1a-n, 140-2 may store, for example, blockchain data defining smart contracts such as pacts (defined below) and pact-based oracle processes (described below) data that causes communications with the management device 106 (e.g., an API and/or API tunnel to a web service that provides blockchain authentication, certification, and/or cryptographic hashing). In some embodiments, the memory devices 140-1a-n, 140-2 may comprise any type, configuration, and/or quantity of data storage devices that are or become known or practicable.

The memory devices 140-1a-n, 140-2 may, for example, comprise an array of optical and/or solid-state hard drives configured to store ledger data provided by (and/or requested by) the node devices 102a-n, and/or various operating instructions, drivers, etc.

While the memory devices 140-1a-n, 140-2 are depicted as stand-alone components of the various node devices 102a-n and the server 110, the memory devices 140-1a-n, 140-2 may comprise multiple components. In some embodiments, a multi-component memory devices 140-1a-n, 140-2 may be distributed across various devices and/or may comprise remotely dispersed components. Any or all of the node devices 102a-n, the management device 106, and/or the server 110 may comprise the memory devices 140-1a-n, 140-2 or a portion thereof, for example.

Any processes described in this disclosure do not necessarily imply a fixed order to any depicted actions, steps, and/or procedures, and embodiments may generally be performed in any order that is practicable unless otherwise and specifically noted.

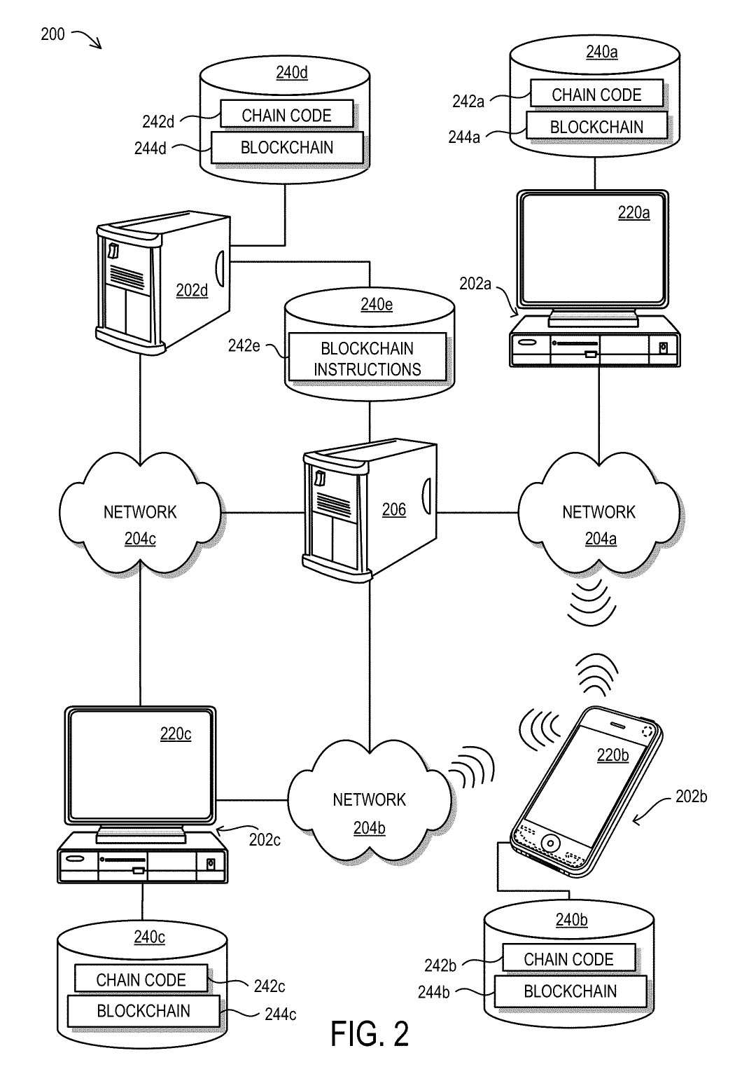

Turning now to FIG. 2, a block diagram of a system 200 according to some embodiments is shown. In some embodiments, the system 200 may comprise a plurality of node devices 202a-d. In some embodiments, any of the node devices 202a-d may be in communication via any of networks 204a-c (e.g., the Internet, a cellphone network, and/or a short-range communication network) with one or more other node devices. In some embodiments, a blockchain services device 206 may be in communication with any or all of the node devices 202a-d, e.g., via the first network 204a, the second network 204c, and/or the third network 204b. According to some embodiments, the system 200 may comprise one or more interfaces 220a-c. Each of the node devices 202a-c may, for example, comprise and/or generate a first, second, or third interface 220a-c, respectively.

According to some embodiments, each device 202a-d, 206 may also or alternatively be in communication with and/or comprise a memory device 240a-e (e.g., any of which may be implemented and/or defined by an object data store and/or other data storage technique and/or service, such as utilizing the Amazon® Simple Storage Service (Amazon® S3™) available from Amazon.com, Inc. of Seattle, Wash. or an open-source third-party database service, such as MongoDB™ available from MongoDB, Inc. of New York, N.Y.).

In some embodiments, each memory device 240a-e may store various instructions and/or data utilized to effectuate a distributed surety bond contract ledger, as described herein. First, second, third, and/or fourth memory devices 240a-d coupled (physically and/or communicatively) to node devices 202a-d, respectively, may store for example, first, second, third, and fourth instances of chain code 242a-d, respectively. The chain code 242a-d may, in some embodiments, comprise specially-coded instructions that cause each respective device 202a-d to operate to generate and/or update a distributed ledger.

According to some embodiments, a fifth memory device 240e coupled (physically and/or communicatively) to the blockchain services device 206 may store blockchain instructions 242e. The blockchain instructions 242e may comprise, for example, specially-coded instructions that cause the blockchain services device 206 to be responsive to queries and/or data transmissions from any or all of the node devices 202a-d. The blockchain instructions 242e may cause, for example, creation and/or editing of a blockchain 244a-d having instances stored throughout the system 200 (e.g., in each of the first, second, third, and/or fourth memory devices 240a-d). In some embodiments, the blockchain instructions 242e may be accessible and/or executed by one or more of the node devices 202a-d (e.g., the node device 202d may operate in place of or in conjunction with the blockchain services device 206).

According to some embodiments, the blockchain 244a-d may comprise a private distributed ledger by being stored only on the devices 202a-d of the system 200. In some embodiments, the blockchain 244a-d may comprise a semi-private or public distributed ledger by including instances stored on additional devices, such as trusted or public devices, respectively (neither of which is shown). According to some embodiments, the chain code 242a-d may include instructions that direct the individual devices 202a-d to initiate a transmission of information (e.g., transactions and other digital messages) to the blockchain services device 206 (e.g., via one or more of the networks 204a-c).

The node device 202a may, for example, initiate distributed ledger creation be generating an initial or first instance of the blockchain 244a by executing a first instance of the chain code 242a. In the case that the node device 202a is utilized to initiate a transaction such as transfer payment, for example, information detailing the transaction may be cryptographically hashed or otherwise processed to generate the first instance of the blockchain 244a.

In some embodiments, the first instance of the chain code 242a may cause the information detailing the transaction (e.g., received via a first interface 220a) to be transmitted to the blockchain services device 206, e.g., via the first network 204a. The blockchain services device 206 may then, for example, conduct authentication, certification, and/or cryptographic processing of the information received from the node device 202a to generate and/or define the first instance of the blockchain 244a. According to some embodiments, the first instance of the blockchain 244a may be transmitted by the blockchain services device 206 to the node device 202a, e.g., causing the first instance of the blockchain 244a to be stored in the first memory device 240a.

According to some embodiments, such as in the case that an entity associated with the principal device 202b desires to provide some digital good in exchange for a transfer payment, a second instance of the chain code 242b may be executed. The second instance of the chain code 242b may, for example, cause information detailing a digital good (e.g., received via the second interface 220b) to be transmitted to the blockchain services device 206 (e.g., via the second network 204b). The blockchain services device 206 may then, for example, conduct authentication, certification, and/or cryptographic processing of the information received from the node device 202b to generate and/or define the second instance of the blockchain 244b. According to some embodiments, the second instance of the blockchain 244b may be transmitted by the blockchain services device 206 to the node device 202b, e.g., causing the second instance of the blockchain 244b to be stored in the second memory device 240b.

Fewer or more components 202a-d, 204a-c, 206, 220a-c, 240a-e, 242a-e, 244a-d and/or various configurations of the depicted components 202a-d, 204a-c, 206, 220a-c, 240a-e, 242a-e, 244a-d may be included in the system 200 without deviating from the scope of embodiments described herein. In some embodiments, the system 200 (and/or one or more portions thereof) may comprise a distributed program, system, and/or platform programmed and/or otherwise configured to execute, conduct, and/or facilitate one or more of the methods described in this disclosure, and/or portions or combinations thereof.

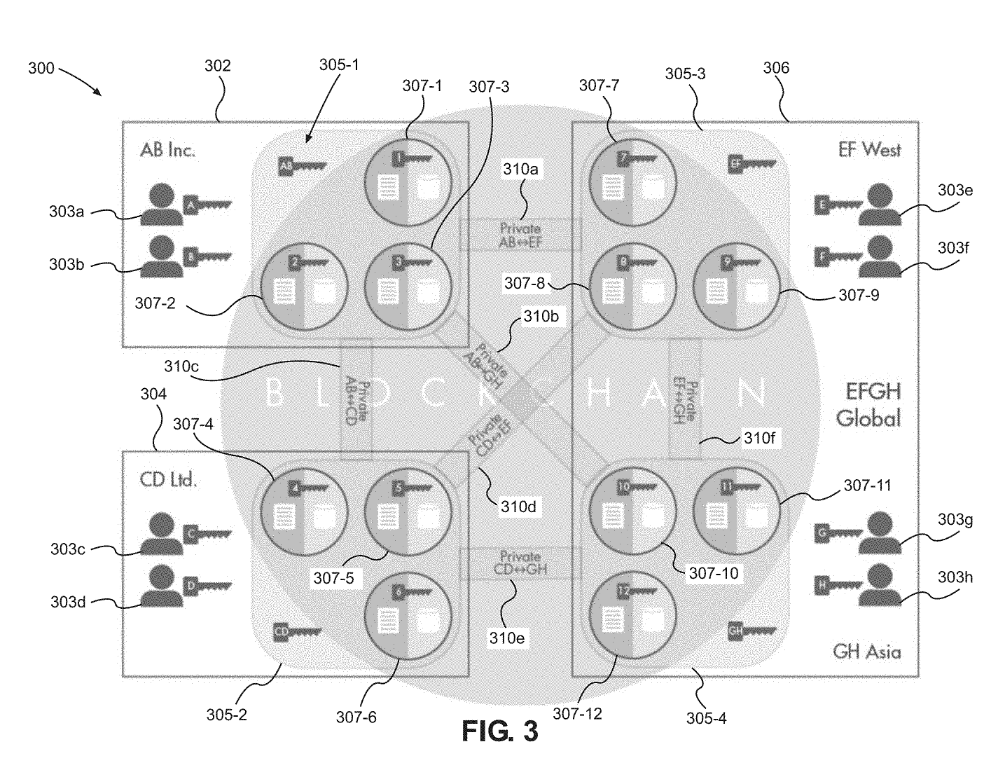

Turning now to FIG. 3, a diagram of an example blockchain system 300 according to some embodiments is shown. Although depicted as a private blockchain configuration (e.g., an inter-organizational blockchain configuration between several companies), it will be readily understood that features of the example blockchain system 300 may be applicable to configurations of public blockchain systems and/or blockchain systems providing for both public and private blockchains.

According to some embodiments, the system 300 may comprise a plurality of entities 302, 304, 306 (e.g., individual companies or organizations). In one embodiment, each entity 302, 304, 306 comprises at least one permissioned user (e.g., one or more of permissioned users 303a-h) having permission to operate within a respective one of entity privacy clusters 305-1, 305-2, 305-3, and 305-4. In one embodiment, each entity 302, 304, 306 operates at least one node of the example blockchain system 300. As depicted, each entity is operating at least three nodes: example company AB Inc. is operating nodes 307-1, 307-2, and 307-3; example company CD Ltd. is operating nodes 307-4, 307-5, and 307-6; example subsidiary EF West of parent EFGH Global is operating nodes 307-7, 307-8, and 307-9; and example subsidiary GH Asia of parent EFGH Global is operating nodes 307-10, 307-11, and 307-12.

As depicted in the example system 300, each node is granted its own cryptographic identity for participating in consensus in the blockchain system 300. Each user is associated with a public key and may sign messages with their respective private key (e.g., of keys A-H). As discussed in this disclosure, keys may be utilized at the smart contract layer for authorizing various types of business and administrative activities.

As depicted in the example system 300, any of entities 302, 304, 306 may establish secure sessions (e.g., sessions 310a-e) with other entities (e.g., to encrypt messages). In some embodiments, any of entity privacy clusters 305-1, 305-2, 305-3, and 305-4 may establish secure sessions (e.g., sessions 310a-f) with another entity privacy cluster.

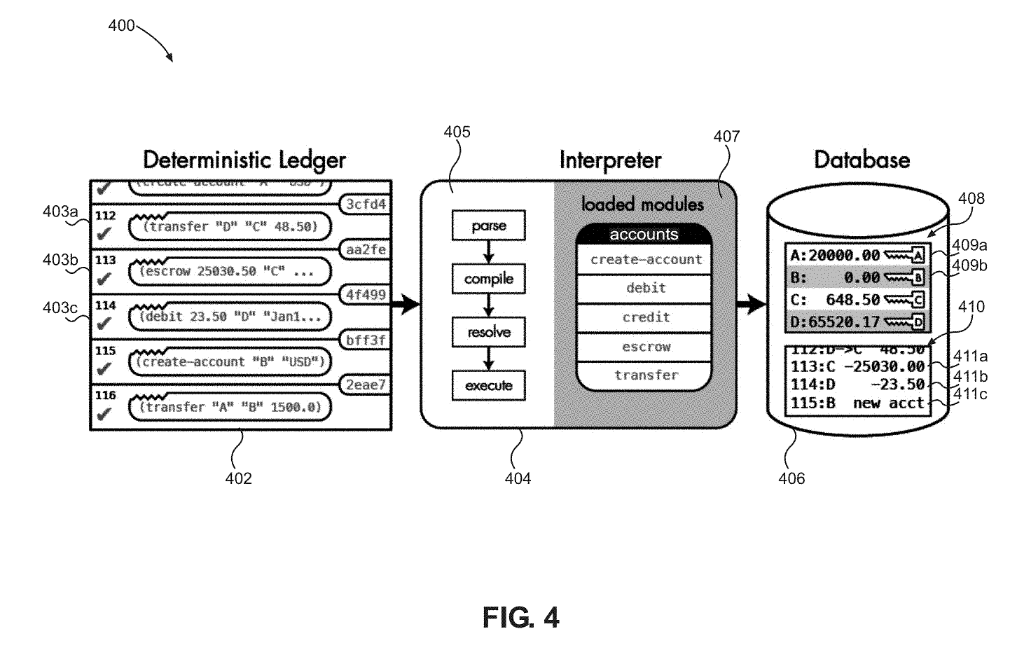

Referring now to FIG. 4, a diagram of an example system 400 for managing a deterministic ledger system (e.g., for smart contracts) according to some embodiments is shown. A distributed ledger 402 comprises a plurality of transactions 403a-403c. As shown in the example of system 400, each transaction 403a-403c comprises a unique and ordered transaction identifier (e.g., “112,” “113,” and so on), a transaction description (e.g., “(transfer “A” “B” 1500.0)”) that describes a description (e.g., by referencing a specific module), and a hash or other type of proof message (e.g., “2eae7”) generated for the transaction.

As depicted in the example system 400, transactions of the deterministic ledger 402 may be interpreted using the interpreter 404. The interpreter 44 may comprise computer instructions configured to implemented one or more methods 405 for receiving, parsing, compiling, resolving, and/or executing smart contracts. Execution may be against one or more types of loaded modules 407 defining one or more functions, types, and tables, and associated data may be stored in one or more databases 406. As discussed in this disclosure, one or more keysets may be defined for guarding administrative and business operations, depending on the desired implementation.

According to some embodiments, the example system 400 may be further be defined by one or more data tables 408, 410 (e.g., associated with a smart contract) stored in a database 406. Data table 408 may comprise, for example, records 409a-b associated with individual users or accounts (e.g., describing balances of cryptocurrency accounts for users “A,” “B,” and so on). Data table 410 may comprise, for example, transaction records 411a-411c describing any changes made to the records 409a-b, with each transaction record being associated with a unique transaction identifier to link the change to a transaction on the blockchain (e.g., stored in deterministic ledger 402).

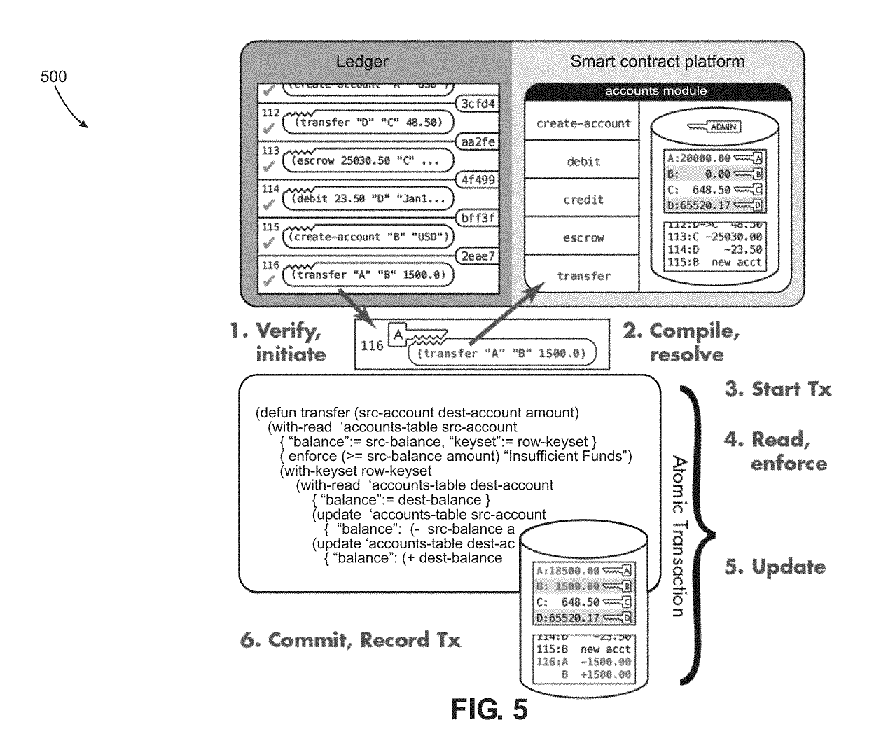

Turning to FIG. 5, flow diagram of a method 500 according to some embodiments is shown. The method 500 involves activity related to an example transaction “116,” defined by a smart contract to transfer a payment from “A” to “B,” that was committed to a ledger (e.g., deterministic ledger 402 of FIG. 4 in accordance with a quorum BFT consensus protocol). After being committed to the ledger, the smart-contract code for the transaction is executed by a processor (e.g., of a virtual machine) of a smart contract platform or other distributed ledger management system. According to the example method 500, the signature on the message submitted for the transaction is verified (e.g., by referencing stored key data) and the message data and the public signing key are passed to a smart-contract execution layer of the platform.

The code module for the smart contract is compiled and any references to loaded modules of the platform are resolved (e.g., the “transfer” function is resolved in a loaded “accounts” module of the platform. In one example, the code module associated with the smart contract is compiled (e.g., by an interpreter) and resolved (e.g., including any inlining of other referenced smart contracts).

The smart-contract execution processing continues, in accordance with some embodiments, by initiating an atomic transaction—any failures or errors will cause the database to fully rollback to its state before the transaction began. In the example depicted in FIG. 5, a smart contract for cryptocurrency-style accounts is being executed. The example “transfer” function depicted in FIG. 5, for example, reads the associated “A” row of the accounts data table to identify its balance and its row-level keyset. Any business logic that is part of the smart contract on which the transaction is based is enforced through execution of the code module (e.g., prohibit transfer for insufficient funds). The example code module logic may further ensure that changes are only made to account records having a row keyset that matches the public key used to sign the message.

On successful completion of the code module, corresponding rows for “A” and “B” may be updated with the adjusted balances, and a transaction log is updated to record all the changes made to the accounts data table, referenced with the transaction identifier (e.g., “116”).

Turning to FIG. 5, flow diagram of a method 500 according to some embodiments is shown. The method 500 involves activity related to an example transaction “116,” defined by a smart contract to transfer a payment from “A” to “B,” that was committed to a ledger (e.g., deterministic ledger 402 of FIG. 4 in accordance with a quorum BFT consensus protocol). After being committed to the ledger, the smart-contract code for the transaction is executed by a processor (e.g., of a virtual machine) of a smart contract platform or other distributed ledger management system. According to the example method 500, the signature on the message submitted for the transaction is verified (e.g., by referencing stored key data) and the message data and the public signing key are passed to a smart-contract execution layer of the platform.

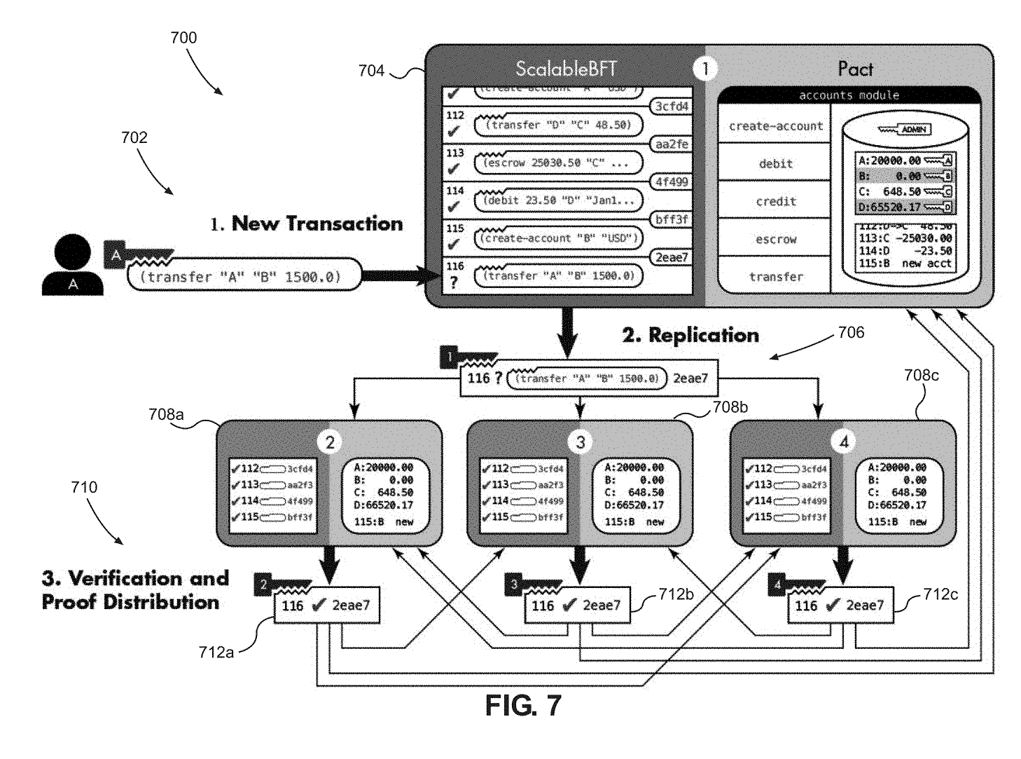

Referring now to FIG. 7, a flow diagram of a method 700 according to some embodiments is shown. The method 700 depicts an example of a consensus process involving a quorum BFT consensus protocol (e.g., ScalableBFT™ of Kadena LLC). Specifically, at 802, a user A submits (e.g., from a client device) a new signed transaction defining a transfer of funds from user A to user B to a leader node of a quorum BFT consensus-managed blockchain platform 804, which adds the transaction to the ledger and assigns it transaction identifier “116.” The leader node computes an incremental hash or other quorum “proof” message (e.g., “2eae7”) based on the transaction (e.g., and based on one or more preceding transactions in a hash-chain) and adds the transaction to its log. The leader node then replicates the transaction to the distributed ledger system by sending, at 806, to a plurality of other nodes (e.g., 808a-c) a message signed by the leader node and including the transaction identifier, the transaction, and the quorum proof message. The method further comprises, at 810, a process phase of verification and proof distribution among the plurality of nodes. Specifically, each node 808a-c generates and signs a respective quorum proof message (e.g., messages 812a-c) and distributes its respective signed message to other nodes in the system. When each node 808a-c receives matching quorum proof messages from a plurality of nodes in the system, the transaction message is committed and can be executed (e.g., in a manner described above with respect to the example method 600 of FIG. 6).

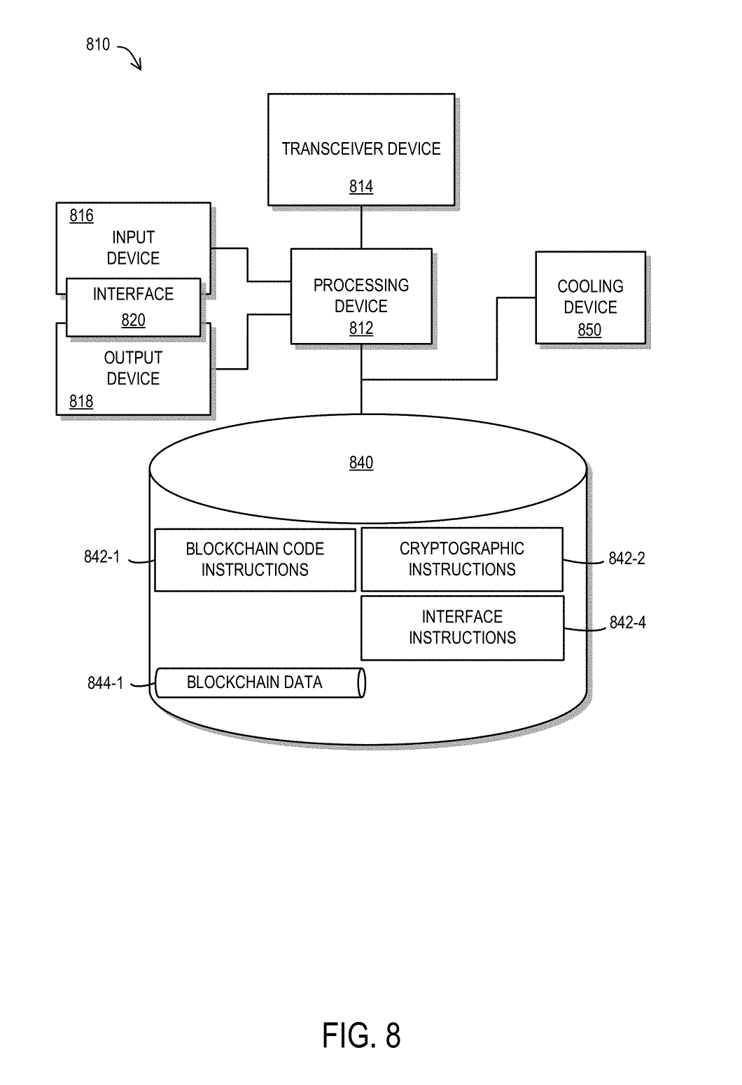

Turning to FIG. 8, a block diagram of an apparatus 810 according to some embodiments is shown. In some embodiments, the apparatus 810 may be similar in configuration and/or functionality to any of the node devices 102a-n, 202a-d, and/or the devices 106, 206, and/or the server devices 110 described herein. The apparatus 810 may, for example, execute, process, facilitate, and/or otherwise be associated with the one or more of the methods described herein, and/or portions or combinations thereof.

In some embodiments, the apparatus 810 may comprise a processing device 812, a transceiver device 814, an input device 816, an output device 818, an interface 820, a memory device 840 (storing various programs and/or instructions 842 and data 844), and/or a cooling device 850. Fewer or more components 812, 814, 816, 818, 820, 840, 842, 844, 850 and/or various configurations of the components 812, 814, 816, 818, 820, 840, 842, 844, 850 be included in the apparatus 810 without deviating from the scope of embodiments described herein.

According to some embodiments, the processor 812 may be or include any type, quantity, and/or configuration of processor that is or becomes known. The processor 812 may comprise, for example, an Intel® IXP 2800 network processor, an Intel® XEON™ Processor coupled with an Intel® E7501 chipset, and/or one or more virtual processors (e.g., associated with a virtual machine). In some embodiments, the processor 812 may comprise multiple inter-connected processors, microprocessors, and/or micro-engines. According to some embodiments, the processor 812 (and/or the apparatus 810 and/or other components thereof) may be supplied power via a power supply (not shown), such as a battery, an Alternating Current (AC) source, a Direct Current (DC) source, an AC/DC adapter, solar cells, and/or an inertial generator. In the case that the apparatus 810 comprises a server, such as a blade server, necessary power may be supplied via a standard AC outlet, power strip, surge protector, and/or Uninterruptible Power Supply (UPS) device.

In some embodiments, the transceiver device 814 may comprise any type or configuration of communication device that is or becomes known or practicable. The transceiver device 814 may, for example, comprise a Network Interface Card (NIC), a telephonic device, a cellular network device, a router, a hub, a modem, and/or a communications port or cable. According to some embodiments, the transceiver device 814 may also or alternatively be coupled to the processor 812. In some embodiments, the transceiver device 814 may comprise an IR, RF, Bluetooth™, Near-Field Communication (NFC), and/or Wi-Fi® network device coupled to facilitate communications between the processor 812 and another device (not shown).

According to some embodiments, the input device 816 and/or the output device 818 are communicatively coupled to the processor 812 (e.g., via wired and/or wireless connections and/or pathways) and they may generally comprise any types or configurations of input and output components and/or devices that are or become known, respectively. The input device 816 may comprise, for example, a keyboard that allows an operator of the apparatus 810 to interface with the apparatus 810 (e.g., by a permissioned user in a blockchain system, such as to submit a request to submit transactions such as a transfer payment to another user that are recorded in a distributed ledger, as described herein).

The output device 818 may, according to some embodiments, comprise a display screen and/or other practicable output component and/or device. The output device 818 may, for example, provide an interface via which distributed ledger information is provided to a user (e.g., via a website and/or mobile application). According to some embodiments, the input device 816 and/or the output device 818 may comprise and/or be embodied in a single device, such as a touch-screen monitor.

The memory device 840 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 840 may, according to some embodiments, store one or more of blockchain code instructions 842-1, cryptographic instructions 842-2, interface instructions 842-4, and/or blockchain data 844-1. In some embodiments, the blockchain code instructions 842-1, cryptographic instructions 842-2, and/or interface instructions 842-4 may be utilized by the processor 812 to provide output information via the output device 818 and/or the transceiver device 814.

According to some embodiments, the blockchain code instructions 842-1 may be operable to cause the processor 812 to process the blockchain data 844-1 in accordance with embodiments as described herein. Blockchain data 844-1 received via the input device 816 and/or the transceiver device 818 may, for example, be interpreted, compiled, analyzed, sorted, filtered, decoded, decompressed, ranked, scored, plotted, and/or otherwise processed by the processor 812 in accordance with the blockchain code instructions 842-1.

In some embodiments, the cryptographic instructions 842-2 may be operable to cause the processor 812 to process the blockchain data 844-1 in accordance with embodiments as described herein (e.g., to generate hashes and/or other types of proof messages).

In some embodiments, the interface instructions 842-4 may be operable to cause the processor 812 to process the blockchain data 844-1 and/or surety data 844-2 in accordance with embodiments as described herein (e.g., to allow users to submit transactions and/or smart contracts to a blockchain platform; to allow administrators to define keysets and associated privileges for one or more smart contracts).

According to some embodiments, the apparatus 810 may comprise the cooling device 850. According to some embodiments, the cooling device 850 may be coupled (physically, thermally, and/or electrically) to the processor 812 and/or to the memory device 840. The cooling device 850 may, for example, comprise a fan, heat sink, heat pipe, radiator, cold plate, and/or other cooling component or device or combinations thereof, configured to remove heat from portions or components of the apparatus 810.

Any or all of the exemplary instructions and data types described herein and other practicable types of data may be stored in any number, type, and/or configuration of memory devices that is or becomes known. The memory device 840 may, for example, comprise one or more data tables or files, databases, table spaces, registers, and/or other storage structures. In some embodiments, multiple databases and/or storage structures (and/or multiple memory devices 840) may be utilized to store information associated with the apparatus 810. According to some embodiments, the memory device 840 may be incorporated into and/or otherwise coupled to the apparatus 810 (e.g., as shown) or may simply be accessible to the apparatus 810 (e.g., externally located and/or situated).

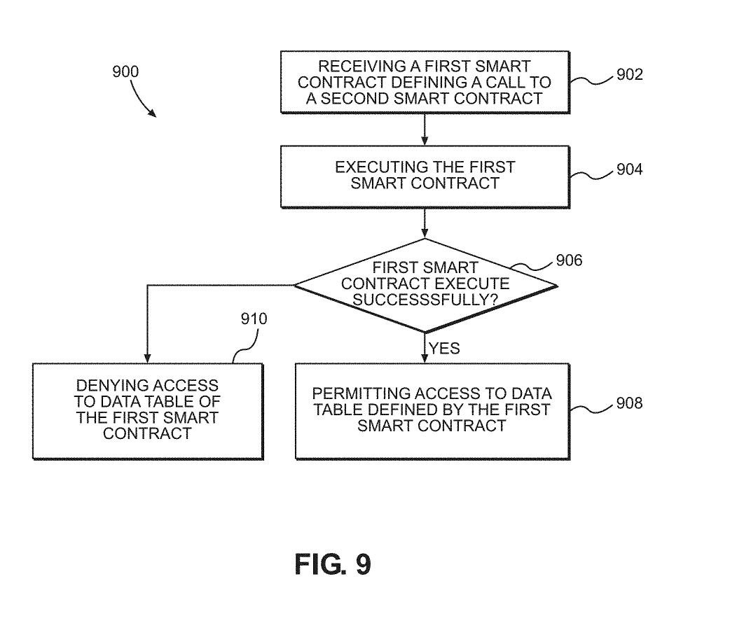

Referring now to FIG. 9, a flow diagram of a method 900 according to some embodiments is shown. According to some embodiments, the method 900 may comprise receiving a first smart contract defining a call to a second smart contract, at 902. In one embodiment, the method 900 may comprise executing the first smart contract (e.g., executing a code module of the first smart contract), at 904. The method 900 may comprise determining whether execution of the first smart contract was successful (e.g., determining whether the full code path of a code module executed), at 906. If so, then the method 900 may comprise permitting access to a data table defined by the first smart contract, at 908; if not, then the method 900 may comprise denying access to the data table defined by the first smart contract, at 910.

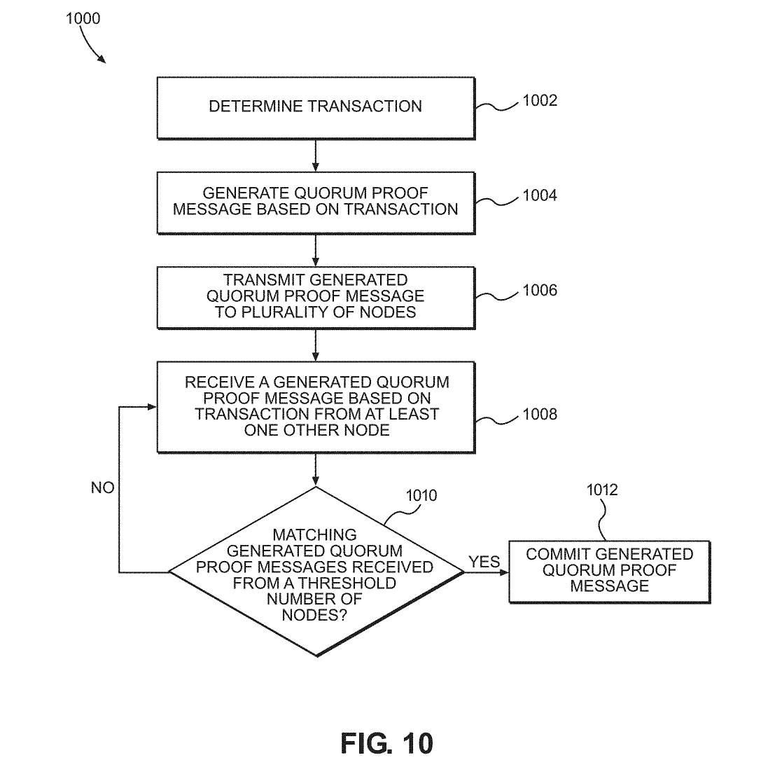

Referring now to FIG. 10, a flow diagram of a method 1000 according to some embodiments is shown. According to some embodiments, the method 1000 may comprise determining a transaction, at 1002, and generating a quorum proof message based on the transaction (e.g., an incremental hash for a hash-chain), at 1004. In one embodiment, the method 1000 may further comprise transmitting the generated quorum proof message to a plurality of other nodes, at 1006, and receiving a generated quorum proof message based on the transaction from at least one other node, at 1008. The method 1000 may further comprise determining whether matching generated quorum messages have been received from and/or generated by a fixed number or a calculated threshold number of nodes (e.g., from a majority of or a specified number of nodes), at 1010. If so, then the method 1000 may comprise committing the generated quorum proof message and/or committing the transaction, at 1012; if not, then the method 1000 may return to 1008 to await the receipt of additional generated quorum proof messages.

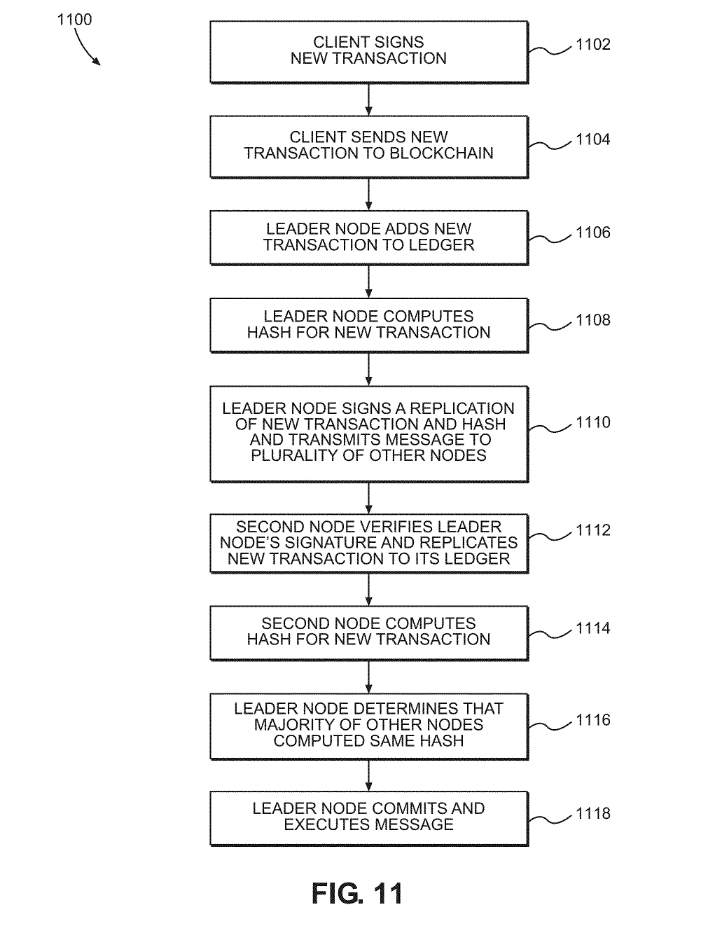

Referring now to FIG. 11, a flow diagram of a method 1100 for quorum-based consensus of blockchain commits according to some embodiments is shown. According to some embodiments, the method 1100 may comprise a client signing a new transaction, at 1102, and sending the new transaction to a leader node of a blockchain, at 1104. The leader node adds the new transaction to the ledger, at 1106, and computes a hash for the new transaction, at 1108. The leader node signs a replication of the new transaction and the hash and transmits a message to a plurality of other nodes, at 1110.

The method 1100 may further comprise a second node verifying the leader node's signature, and replicating the new transaction to the second node's ledger, at 1112. The second node computes a hash for the new transaction, at 1114.

The method 1100 may further comprise, in accordance with some embodiments, the leader node determining that a majority of other nodes (e.g., according to a majority BFT consensus protocol, such as ScalableBFT) computed the same hash that the first node computer, at 1116, and the first node committing and executing the message, at 1118. According to some embodiments, the step of determining whether a majority of nodes computed the same hash may be performed by at least one node that is not the leader node, in addition to or as an alternative to the leader node making the determination. In one embodiment, all nodes must make the determination before the message is committed and executed in a distributed ledger system.

### Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (set forth at the beginning of the first page of this disclosure) nor the Abstract (set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

Some embodiments may be associated with a “user device” or a “network device.” As used in this disclosure, the terms “user device” and “network device” may be used interchangeably and may generally refer to any device that can communicate via a network. Examples of user or network devices include a personal computer (PC), a workstation, a server, a printer, a scanner, a facsimile machine, a copier, a personal digital assistant (PDA), a storage device (e.g., a disk drive), a hub, a router, a switch, and a modem, a video game console, or a wireless phone. User and network devices may comprise one or more communication or network components.

Some embodiments may be associated with a “network” or a “communication network”. As used in this disclosure, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. In some embodiments, networks may be hard-wired, wireless, virtual, neural, and/or any other configuration or type of network that is or becomes known. Networks may comprise any number of computers and/or other types of devices in communication with one another, directly or indirectly, via a wired or wireless medium such as the Internet, LAN, WAN or Ethernet (or IEEE 802.3), Token Ring, RF, cable TV, satellite links, or via any appropriate communications means or combination of communications means. In some embodiments, a network may include one or more wired and/or wireless networks operated in accordance with any communication standard or protocol that is or becomes known or practicable. Exemplary protocols for network communications include but are not limited to: the Fast Ethernet LAN transmission standard 802.3-2002® published by the Institute of Electrical and Electronics Engineers (IEEE), Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Communication between and/or among devices may be encrypted to ensure privacy and/or prevent fraud in any one or more of a variety of ways well known in the art.

Devices that are in communication with each other need not be in continuous communication with each other, unless expressly specified otherwise. On the contrary, such devices need only transmit to each other as necessary or desirable and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

As used in this disclosure, the term “network component” may refer to a network device, or a component, piece, portion, or combination of a network device. Examples of network components may include a Static Random Access Memory (SRAM) device or module, a network processor, and a network communication path, connection, port, or cable.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described in this disclosure are associated with an “indication”. The term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

“Determining” something may be performed in a variety of manners and therefore the term “determining” (and like terms) includes calculating, computing, deriving, looking up (e.g., in a table, database or data structure), ascertaining, recognizing, and the like.

A “processor” means any one or more microprocessors, Central Processing Unit (CPU) devices, computing devices, microcontrollers, digital signal processors, or like devices. Examples of processors include, without limitation, INTEL's PENTIUM, AMD's ATHLON, or APPLE's A6 processor.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate). Where more than one device or article is described in this disclosure (whether or not they cooperate), a single device or article may alternatively be used in place of the more than one device or article that is described. For example, a plurality of computer-based devices may be substituted with a single computer-based device. Accordingly, functionality that is described as being possessed by more than one device or article may alternatively be possessed by a single device or article. The functionality and/or the features of a single device that is described may be alternatively embodied by one or more other devices that are described but are not explicitly described as having such functionality and/or features. Thus, other embodiments need not include the described device itself, but rather can include the one or more other devices that would, in those other embodiments, have such functionality/features.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

It will be readily apparent that the various methods and algorithms described in this disclosure may be implemented by, e.g., appropriately- and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

Accordingly, a description of a process likewise describes at least one apparatus for performing the process, and likewise describes at least one computer-readable medium and/or computer-readable memory for performing the process. The apparatus that performs a described process may include components and/or devices (e.g., a processor, input and output devices) appropriate to perform the process. A computer-readable medium may store program elements and/or instructions appropriate to perform a described method.

The term “computer-readable medium” refers to any medium that participates in providing data (e.g., instructions or other information) that may be read by a computer, a processor, or a like device. Various forms of computer-readable media may be involved in carrying data, including sequences of instructions, to a processor. For example, sequences of instruction (i) may be delivered from RAM to a processor, (ii) may be carried over a wireless transmission medium, and/or (iii) may be formatted according to any one or more of various known formats, standards, or protocols (some examples of which are described in this disclosure with respect to communication networks).

Computer-readable media may take many forms, including but not limited to, non-volatile media, volatile media, and transmission media. Non-volatile media may include, for example, optical or magnetic disks and other types of persistent memory. Volatile media may include, for example, DRAM, which typically constitutes the main memory for a computing device. Transmission media may include, for example, coaxial cables, copper wire, and fiber optics, including the wires that comprise a system bus coupled to the processor. Transmission media may include or convey acoustic waves, light waves, and electromagnetic emissions, such as those generated during RF and IR data communications. Common forms of computer-readable media include, for example, a floppy disk, a flexible disk, a hard disk, magnetic tape, any other magnetic medium, a CD-ROM, DVD, any other optical medium, a punch card, paper tape, any other physical medium with patterns of holes, a RAM, a PROM, an EPROM, a FLASH-EEPROM, a Universal Serial Bus (USB) memory stick or thumb drive, a dongle, any other memory chip or cartridge, a carrier wave, or any other medium from which a computer can read.

The term “computer-readable memory” may generally refer to a subset and/or class of non-transitory computer-readable medium that does not include intangible or transitory signals, waves, waveforms, carrier waves, electromagnetic emissions, or the like. Computer-readable memory may typically include physical, non-transitory media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, USB devices, any other memory chip or cartridge, and the like.

Where databases are described, it will be understood by one of ordinary skill in the art that (i) alternative database structures to those described may be readily employed, and (ii) other memory structures besides databases may be readily employed. Any illustrations or descriptions of any sample databases presented in this disclosure are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries may be different from those described in this disclosure. Further, despite any depiction of the databases as tables, other formats (including relational databases, object-based models, hierarchical electronic file structures, and/or distributed databases) could be used to store and/or manipulate the described data. Likewise, object methods or behaviors of a database may be used to implement one or more of various processes, such as those described in this disclosure. In addition, the databases may, in a known manner, be stored locally and/or remotely from a device that accesses data in such a database. Furthermore, while unified databases may be contemplated, it is also possible that the databases may be distributed and/or duplicated amongst a variety of devices.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. A system for controlling access to information stored in a distributed ledger environment, the system comprising:
a processing device; and
a memory device in communication with the processor, the memory device storing operating instructions and programmatic code defining a blockchain application operable to manage a distributed ledger, wherein executing of the operating instructions by the processing device results in:
receiving a first smart contract comprising a first data table, a first keyset, and a first code module,
wherein successful execution of the first code module is required for access to the first data table;
executing the first smart contract;
determining whether the first smart contract executed successfully; and
performing one of:
permitting access to the first data table if the first smart contract executed successfully, or
denying access to the first data table if the first smart contract did not execute successfully.

2. The system of claim 1, wherein the first code module defines a call to a second smart contract, the second smart contract comprising a second data table, a second keyset, and a second code module.

3. The system of claim 2, wherein the second smart contract comprise a coroutine defining a multi-step function.

4. The system of claim 2, wherein the second smart contract defines a multi-step oracle process.

5. The system of claim 2, wherein the second smart contract defines an automated push-based oracle process.

6. The system of claim 2, wherein the second smart contract defines an automated pull-based oracle process.

7. The system of claim 2, wherein the first smart contract is authored by a first entity and the second smart contract is authored by a second entity.

8. The system of claim 1, wherein successful execution of the second code module is required for access to the second data table.

9. The system of claim 1, wherein executing of the operating instructions by the processing device further results in compiling the first smart contract.

10. The system of claim 8, wherein compiling the first smart contract comprising importing a second code module of a second smart contract inline in the first code module.

11. The system of claim 1, wherein executing of the operating instructions by the processing device further results in:
receiving a key; and
verifying authorization to execute the first smart contract based on the received key and the first keyset; and
executing defined logic of the first smart contract.

12. The system of claim 1, wherein executing of the operating instructions by the processing device further results in:
receiving a key; and
verifying authorization to execute a second smart contract based on the received key and the second keyset.

13. The system of claim 1, wherein executing of the operating instructions by the processing device further results in:
determining that the first smart contract executed successfully; and
committing a change to the distributed ledger.

14. The system of claim 1, wherein executing the first smart contract comprises:
initiating a first step of the first code module;
yielding execution of the first code module;
receiving a message;
in response to receiving the message, resuming execution of the first smart contract in a second step.

15. The system of claim 1, wherein executing the first smart contract comprises:
in a first step, calling a second smart contract by the first smart contract;
yielding execution of the first smart contract;
receiving a response by the second smart contract;
in response to receiving the response, in a second step, resuming execution of the first smart contract; and
validating the response from the second smart contract.

16. A method for controlling access to information stored in a distributed ledger environment, comprising:
receiving a first smart contract comprising a first data table, a first keyset, and a first code module,
wherein the first code module defines a call to a second smart contract, the second smart contract comprising a second data table, a second keyset, and a second code module,
wherein successful execution of the first code module is required for access to the first data table, and
wherein successful execution of the second code module is required for access to the second data table;
executing the first smart contract;
determining whether the first smart contract executed successfully; and
performing one of:
permitting access to the first data table if the first smart contract executed successfully, or
denying access to the first data table if the first smart contract did not execute successfully.

17. The method of claim 16, wherein the first code module defines a call to a second smart contract, the second smart contract comprising a second data table, a second keyset, and a second code module.

18. The method of claim 17, wherein the second smart contract comprise a coroutine defining a multi-step function.

19. The method of claim 17, wherein the second smart contract defines a multi-step oracle process.

20. The method of claim 17, wherein the second smart contract defines an automated push-based oracle process.

21. The method of claim 17, wherein the second smart contract defines an automated pull-based oracle process.

22. The method of claim 17, wherein the first smart contract is authored by a first entity and the second smart contract is authored by a second entity.

23. The method of claim 16, wherein successful execution of the second code module is required for access to the second data table.

24. The method of claim 16, further comprising:
compiling the first smart contract.

25. The system of claim 24, wherein compiling the first smart contract comprising importing a second code module of a second smart contract inline in the first code module.

26. The method of claim 16, further comprising:
receiving a key; and
verifying authorization to execute the first smart contract based on the received key and the first keyset; and
executing defined logic of the first smart contract.

27. The method of claim 16, further comprising:
receiving a key; and
verifying authorization to execute a second smart contract based on the received key and the second keyset.

28. The method of claim 16, further comprising:
determining that the first smart contract executed successfully; and
committing a change to the distributed ledger.

29. The method of claim 16, wherein executing the first smart contract comprises:
initiating a first step of the first code module;
yielding execution of the first code module;
receiving a message;
in response to receiving the message, resuming execution of the first smart contract in a second step.

30. The method of claim 16, wherein executing the first smart contract comprises:
in a first step, calling a second smart contract by the first smart contract;
yielding execution of the first smart contract;
receiving a response by the second smart contract;
in response to receiving the response, in a second step, resuming execution of the first smart contract; and
validating the response from the second smart contract.
